(19) United States
(12) Patent Application Publication
(10) Pub. No.: US 2011/0152138 A1
(43) Pub. Date: Jun. 23, 2011

(54) ROLLING BEARING AND MANUFACTURING METHOD THEREOF

(75) Inventors: Tsuyoshi Nakai, Kanagawa (JP); Keiji Yasunaga, Kanagawa (JP); Tomohiro Motoda, Kanagawa (JP); Yuichi Endo, Kanagawa (JP); Mamoru Aoki, Kanagawa (JP); Koji Ueda, Kanagawa (JP); Katsunori Yanase, Kanagawa (JP); Satoru Watanabe, Kanagawa (JP); Hiroshi Ishiwada, Kanagawa (JP); Shun Nishizeki, Kanagawa (JP); Norikazu Kitagawa, Kanagawa (JP)

(73) Assignee: NSK LTD., Tokyo (JP)

(21) Appl. No.: 13/060,481

(22) PCT Filed: May 21, 2010
(86) PCT No.: PCT/JP2010/058647

§ 371 Date: Feb. 24, 2011

(30) Foreign Application Priority Data
May 21, 2009 (JP) 2009-123072
Feb. 19, 2010 (JP) 2010-035213

(51) Int. Cl. F16C 33/06; F16C 33/48; C04B 35/645

(52) U.S. Cl. 508/103; 384/572; 264/681

(57) ABSTRACT

To provide a rolling bearing which is superior in preventing electrolytic corrosion, suitable for use in applications where torque reduction of the bearing is required by reducing an amount of lubricant used or by using a lubricant having a low viscosity, and has superior acoustic characteristics and durability, a rolling element according to the present invention is made of an alumina-zirconia composite material including an alumina component and either a zirconia component or a yttria-zirconia component containing 1.5 to 5 mol % of yttria, a mass ratio of the alumina component to the zirconia component or the yttria-zirconia component being 5:95 to 50:50.

### TECHNICAL FIELD

The present invention relates to a rolling bearing suitable for use in, for example, inverter-controlled motors such as motors for air conditioner fans or compressors, pivot arms for supporting a swing arm of an HDD and oscillating motors such as servo motors or stepping motors.

### BACKGROUND ART

In many cases, air conditioner fan motors and compressor motors are inverter controlled to save energy. However, there may be a situation in which a high-frequency current is generated from the inverter circuit to flow to inner and outer rings or rolling elements of a bearing in the motor, whereby an electrolytic corrosion is generated in rolling contact surfaces (raceway surfaces).

There have been made various proposals, and for example, it is proposed to provide an insulation layer made of a synthetic resin or thermoplastic elastomer, synthetic rubber or ceramic on a raceway surface of a baring ring (for example, refer to Patent Document). In addition, while electrolytic corrosion can be prevented by use of a rolling bearing which use ceramic rolling elements, in a rolling bearing using rolling elements made of general silicon nitride as ceramic, there is still room for improvement in acoustic characteristics and torque performance. Namely, since the surface of a rolling element made of silicon nitride is originally difficult to be wet with oil, when a lubricant having a low viscosity to reduce the torque of a bearing, an oil film formed on the surface of the rolling element becomes so thin that a discontinuity is easily generated in the oil film.

Because of this, when the lubricant having a low viscosity is use, the raceway surfaces, which are made of bearing steel whose hardness is lower than that of silicon nitride, tends to be easily damaged. Consequently, in the rolling bearing using the rolling elements made of silicon nitride, in case maintenance such as a periodical supply of lubricant is not implemented, the preload is lost due to a difference in linear expansion coefficient between the steel of which the inner and outer rings are made and silicon nitride of which the rolling elements are made when the rotating speed of the bearing is increased, resulting in a possibility that a gap is produced (Patent Document 2).

In addition, zirconia is also used as ceramic. The linear expansion coefficient of zirconia is close to the steel of which the bearing is made of, and hence, zirconia has an advantage that when used in a bearing, preload is made difficult to be lost. In addition, since zirconia in which MgO or CaO, Y₂O₃, CeO₂ or the like is dispersed has high strength and high toughness (Non-Patent Document 1), a bearing made of zirconia can enjoy a long life. Further, to produce inexpensive bearings while making use of high strength and high toughness provided by zirconia, it is also proposed to add alumina in a ratio of zirconia-yttria to alumina being 100:1 to 60:40 (Patent Document 3). However, as with silicone nitride, when a lubricant having a low viscosity is used, there may be a situation in which the oil film discontinues. Further, when ester-based lubricating oil having a polarity is used as a lubricant, the wear of rolling element tends to be accelerated.

### PRIOR ART DOCUMENTS

### Patent Documents

Patent Document 1: JP 07-310748 A
Patent Document 2: JP 2002-139048 A
Patent Document 3: JP 2002-106570 A

### Non-Patent Document

Non-Patent Document 1: Shigeyuki Munemia and Masahiro Yoshimura, Zirconia Ceramics 9, Uchida Rokakuho, pp. 47-69 and pp. 73-79

### SUMMARY OF INVENTION

### Problem that the Invention is to Solve

It is an object of the invention is to provide a rolling bearing which is superior in preventing electrolytic corrosion, suitable for use in applications where torque reduction of the bearing is required by reducing an amount of lubricant used or by using a lubricant having a low viscosity, and has superior acoustic characteristics and durability.

### Means for Solving the Problem

With a view to solving the problem, the present invention provides the following rolling bearing and manufacturing method thereof.

(1) A rolling bearing having at least an inner ring, an outer ring, a rolling element, and a cage, wherein the rolling element is made of an alumina-zirconia composite material including an alumina component and either a zirconia component or a yttria-zirconia component containing 1.5 to 5 mol % of yttria, a mass ratio of the alumina component to the zirconia component or the yttria-zirconia component being 5:95 to 50:50.
(2) The rolling bearing as set forth in (1) described above, wherein alumina particles and either zirconia particles or yttria-zirconia particles in the rolling element respectively have an average particle diameter of 2 μm or smaller.
(3) The rolling bearing as set forth in (1) or (2) described above, wherein each content of SiO₂, Na₂O and Fe₂O₃ in the rolling element is 0.3 mass % or smaller respectively.
(4) The rolling bearing as set forth in any one of (1) to (3) described above, wherein, in a surface of the rolling element, number of zirconia agglomerates or yttria-zirconia agglomerates having a size of 10 to 30 μm is five or less per 300 mm².
(5) The rolling bearing as set forth in any one of (1) to (4) described above, wherein Young's modulus of the rolling element is 215 to 280 GPa.
(6) The rolling bearing as set forth in any one of (1) to (5) described above, wherein a density of the rolling element is 4.5 to 6 g/cm³.
(7) The rolling bearing as set forth in any one of (1) to (6) described above, wherein the cage is made of a synthetic resin composition.
(8) The rolling bearing as set forth in any one of (1) to (7) described above, wherein at least one of the inner ring and the outer ring is carbonitrided.
(9) The rolling bearing as set forth in any one of (1) to (8) described above, wherein an ester oil having kinematic viscosity of 80 mm²/s or smaller at 40° C. or a grease using the ester oil as a base oil is enclosed to occupy 20 vol % or less of a bearing space.
(10) The rolling bearing as set forth in any one of (1) to (8) described above, wherein a nonpolar lubricating oil having kinematic viscosity of 80 mm²/s or smaller at 40° C. and having no polar group in molecules, or a grease using the nonpolar lubricating oil as a base oil is enclosed to occupy 20 vol % or smaller of a bearing space.
(11) A rolling bearing manufacturing method, the rolling bearing having at least an inner ring, an outer ring, a rolling element, and a cage, the method including mixing alumina raw material powers and either zirconia raw material powders or yttria-zirconia raw material powers containing 1.5 to 5 mol % of yttria, in a mass ratio of the alumina raw material powders to the zirconia raw material powders or the yttria-zirconia raw material powders being 5:95 to 50:50, molding the mixture into a shape of the rolling element, and sintering, after the molding, the molded mixture to fabricate the rolling element.
(12) The rolling bearing manufacturing method as set forth in (11) described above, wherein the mixing includes pulverizing the alumina raw material powder and either the zirconia raw material powder or the yttria-zirconia raw material powder inside a bead mill mixer together with zirconia beads having a diameter of 1 mm or smaller.

### Advantage of the Invention

According to the invention, the rolling bearing is provided which has an electrolytic corrosion preventing capability which is equal to that of a rolling bearing employing rolling elements made of silicon nitride, which can ensure a sufficient lubricating performance with a small amount of a lubricant having a low viscosity, which is suitable for use in applications which require a low torque and which has superior acoustic characteristics and durability.

### BRIEF DESCRIPTION OF THE DRAWINGS

FIG. 1 is a sectional view showing a ball bearing which is an embodiment of a rolling bearing according to the invention;

FIG. 2 is an exemplary diagram showing an example of a bead mill mixer;

FIG. 3 is a chart obtained from Test 4, showing temporal changes in friction coefficient when a ball specimen made of SUJ2 steel is used;

FIG. 4 is a graph obtained from Test 4, showing specific wear rates of the ball specimen made of SUJ2 steel;

FIG. 5 is a chart obtained from Test 4, showing temporal changes in friction coefficient when a ball specimen made of an alumina-zirconia composite material is used;

FIG. 6 is a graph obtained from Test 4, showing specific wear rates of a disc specimen when the ball specimen made of the alumina-zirconia composite material is used;

FIG. 7 is a chart obtained from Test 4, showing measured temporal changes in surface condition of the ball specimen made of the alumina-zirconia composite material;

FIG. 8 is a chart obtained from Test 4, showing measured temporal changes in surface condition of the ball specimen made of the alumina-zirconia composite material;

FIG. 9 is a graph obtained from Test 4, showing ratios of specific wear rates;

FIG. 10 is an exemplary diagram illustrating a thrust test method in Test 5;

FIG. 11 is a graph obtained from Test 5, showing a relationship between ratios of alumina component and zirconia component and life ratios;

FIG. 12 is a graph obtained from Test 6, showing relationships between contents of iron oxide and lives;

FIG. 13 is a graph obtained from Test 6, showing relationships between contents of iron oxide and vibration values;

FIG. 14 is a graph obtained from Test 7, showing a relationship between average particle diameters and lives;

FIG. 15 is a graph obtained from Test 8, showing a relationship between major axis dimension of zirconia agglomerates and lives;

FIG. 16 is a graph obtained from Test 9, in which the numbers of zirconia agglomerates of various sizes in the surface of a rolling element is calculated;

FIG. 17 is a graph obtained from Test 9, showing a relationship between the numbers of zirconia agglomerates of 10 to 30 μm per 300 mm² and lives;

FIG. 18 is a graph obtained from Test 10, showing relationships between the numbers of zirconia agglomerates of 10 to 30 μm per 300 mm² and lives;

FIG. 19 is a graph obtained from Test 11, showing results of a test carried on life of a ball specimen B; and

FIG. 20A is an SEM photograph of an internal texture of a ball specimen A, and FIG. 20B is an SEM photograph of an internal texture of the ball specimen B, which are obtained from Test 11;

### EMBODIMENTS OF THE INVENTION

Hereinafter, the invention will be described in detail by reference to the drawings.

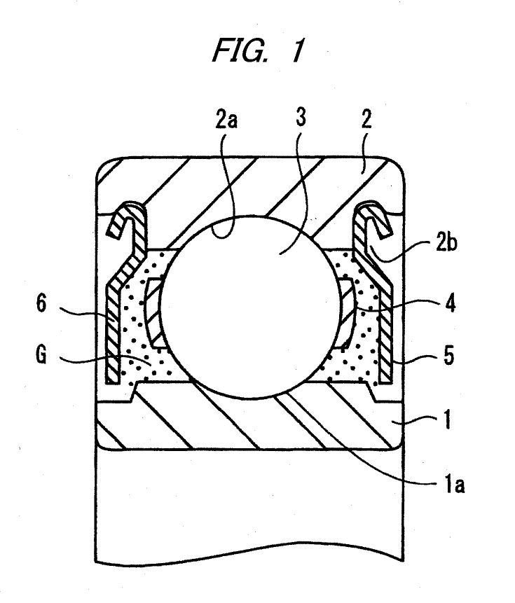

Structure of a rolling bearing of the invention in not particularly limited, provided that a bearing to which the invention is applied is such as to be used in, for example, inverter-controlled motors such as motors for air conditioner fans or compressors, pivot arms for supporting a swing arm of an HDD, and oscillating motors such as servo motors or stepping motors, and a ball bearing like one shown in a sectional view in FIG. 1 can be taken as an example.

The illustrated ball bearing is configured such that balls 3 being a plurality of rolling elements are retained by a cage 4 between an inner ring raceway surface 1a formed on an outer circumferential surface of an inner ring 1 and an outer ring raceway surface 2a formed on an inner circumferential surface of an outer ring 2, and a lubricant G filled in a bearing space 6 defined by the inner ring 1, the outer ring 2 and the balls 3 is enclosed therein by seals 5. Note that reference numeral 2b denotes a seal fitting groove provided in the outer ring 2. In the invention, the inner ring 1 and the outer ring 2 are made of a metal such as SUJ2 steel, SUS steel or 13Cr steel and the balls 3 are made of an alumina-zirconia composite material which contains an alumina component and a zirconia component or yttria-zirconia component. In this way, by making the inner ring 1 and the outer ring 2 and the balls 3 of a combination of different types of materials, the adhesion between the inner ring 1 and the balls 3 and between the outer ring 2 and the balls 3 can be prevented which would otherwise be produced due to a reduction in amount of lubricant G for reduction in torque or a use of lubricant G having a low kinematic viscosity. In addition, since the balls 3 are made of the alumina-zirconia composite material which is electrically insulating, electrolytic corrosion can be prevented.

Silicon nitride, which is a general ceramic material as a bearing material, is a microcrystal in which needle crystals are interwound, and its maximum particle diameter is 30 to 50 μm with an aspect ratio being about 2. In contrast to this, the alumina-zirconia composite material contains an alumina component and a zirconia component or yttria-zirconia component in the following ratio, and sintered particles of alumina (hereinafter, alumina sintered particles) and sintered particles of zirconia (hereinafter, zirconia sintered particles) or sintered particles of yttria-zirconia (hereinafter, yttria-zirconia sintered particles) which are all obtained by sintering the respective components are all fine substantially spherical matters whose average particle diameter is 2 μm or smaller. Because of this, when the bearing is operated for a long period of time, crystalline grains in the surfaces of the balls 3 wear and fall. Therefore, irregularities in the surfaces of the balls of silicon nitride whose particle diameter is large become larger than irregularities in the surfaces of the balls 3 of the alumina-zirconia composite material whose particle diameter is small, and there is a tendency that the raceway surfaces 1a, 2a are damaged severely.

In terms of mass ratio, a ratio of alumina component to zirconia component or yttria-zirconia component, i.e., alumina component: zirconia component or yttria-zirconia component is preferably 5:95 to 50:50, more preferably 10:90 to 30:70, and most preferably 20:80.

In addition, alumina sintered particles are compressed due to a difference in volume shrinkage occurring when cooled down from the sintering temperature to room temperature, and tensile stress is imparted to zirconia sintered particles or yttria-zirconia sintered particles, whereby cracks propagate by way of the zirconia sintered particles or yttria-zirconia sintered particles due to a difference in distribution of residual stress. Further, although cracks propagate in the alumina sintered particles which are weak in strength, compression stress is loaded on the alumina sintered particles due to transformation of zirconia sintered particles or yttria-zirconia sintered particles (tetragonal to monoclinic), whereby the propagation of cracks is prevented.

In particular, when the zirconia component or yttria-zirconia component is less than 70 mass %, it is difficult that the effectiveness of loading the compression stress on the alumina sintered particles due to phase transformation appears, and strength is reduced. In addition, when the zirconia component or yttria-zirconia component surpasses 90 mass %, particle growth or cohesion tends to occur easily, and strength is reduced by zirconia sintered particles or yttria-zirconia sintered particles which have abnormally grown.

In addition, in the yttria-zirconia component, 1.5 mol % to 5 mol % of yttria is contained, and the content of yttria is preferably 3 mol %. When yttria is added to zirconia to be solid dissolved, oxygen vacancies are formed in the structure, and cubic and tetragonal systems become stable or metastable to increase strength. The suitable yttria content in zirconia therefor is 1.5 to 5 mol %. When the yttria content is less than 1.5 mol %, a sintered compact of a tetragonal system cannot be obtained, whereas when the yttria content is 5 mol % or more, tetragonal systems are reduced and cubic systems become a main substance. Therefore, the resulting yttria-zirconia component cannot be strengthened highly by the transformation.

To fabricate the balls 3, alumina raw material powder and zirconia raw material powder or yttria-zirconia raw material powder are mixed to realize the aforesaid component ratios, the resulting mixture is formed into a spherical shape, the formed mixture is degreased and sintered, and the resulting sintered compact is HIP treated. As this occurs, to make the sintered compact denser, it is preferable that impurities contained in each raw material powder are as little as possible. In particular, reducing SiO₂, Fe₂O₃ and Na₂O as much as possible improves the ability of sintering and becomes effective in densification. Further, early flaking attributed to impurities can be suppressed. To be specific, the content of each of SiO₂, Fe₂O₃ and Na₂O is preferably 0.3 mass % or less and is more preferably 0.1 mass % or less and is much more preferably 0.02 mass % or less. When the content surpasses 0.3 mass %, the fall of fine particles from the surface of the rolling element tends to occur easily in operation, a reduction in roughness of the surface of the rolling element and fine damage to the raceway surfaces by the fallen particles are caused, leading to a fear that vibration is increased to shorten acoustic life. In addition, the fatigue life of the rolling element also becomes a cause for triggering early flaking initiated by impurities.

Note that a compression molding is generally used as a molding method, and a sintered stock material (stock ball) is prepared into a predetermined spherical shape by grinding and polishing. In addition, the HIP treatment can be implemented under normal conditions.

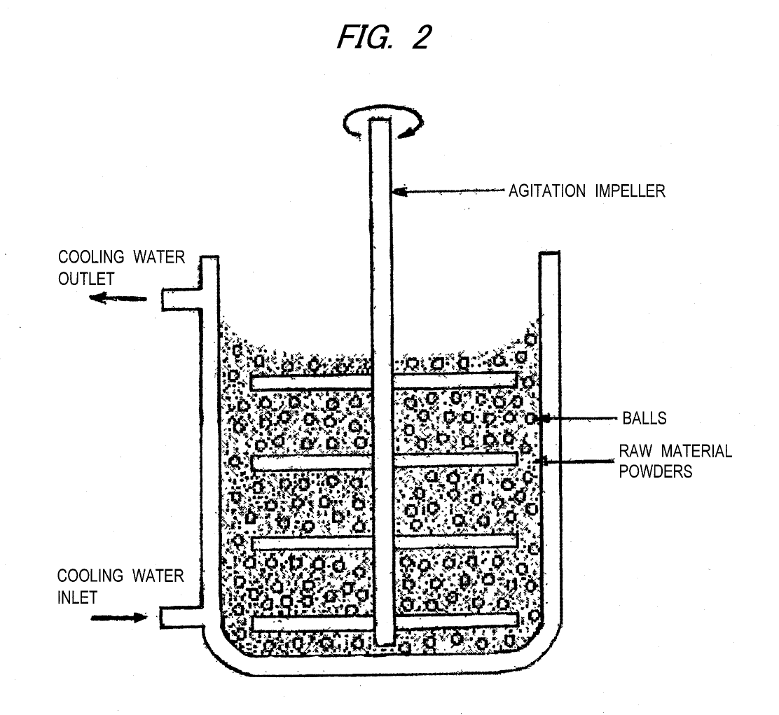

In addition, when alumina raw material powder and zirconia raw material power or yttria-zirconia raw material powder are not mixed uniformly and segregation is generated in each of alumina and zirconia or yttria-zirconia sintered particles, the rolling fatigue life tends to be reduced. In particular, this becomes remarkable when sintered particles whose particle diameters surpass 100 μm are present. As a method for preventing segregation, not only do the raw material powders need to be mixed uniformly, but also mixing accompanied by strong pulverization needs to be implemented. To make this happen, although a ball mill mixer can be used, the use of a bead mill mixer is most effective which employs zirconia beads whose diameter is 1 mm or smaller as a pulverization medium. FIG. 2 is an exemplary diagram showing an example of a bead mill mixer. Alumina raw material powder, zirconia raw material powder or yttria-zirconia raw material powder and water or alcohol are introduced together with beads into a container having an agitation impeller disposed in a center thereof so as to mix and pulverize the powders together. The rotational speed of the agitation impeller can be increased up to 3000 rpm as a maximum speed, and cooling water is caused to flow into the container during mixing. In contrast to this, in the ball mill mixer, the diameter of a pulverization medium is 10 mm or larger, and the rotational speed of a agitation impeller is about 400 to 1000 rpm. Thus, the pulverization efficiency of the bead mill mixer is much higher that that of the ball mill mixer.

The average particle diameters of alumina sintered particles, zirconia sintered particles or yttria-zirconia sintered particles in the ball 3 are preferably 2 μm or smaller and are more preferably 1 μm or smaller. Normally, when sintered, particles grow to some extent, and as is described in Japanese Patent No. 3910310, in case particles whose particle diameters are 10 μm or larger are present, the life of the ball 3 is badly affected. However, by using such a composite material for the ball 3, the effectiveness that the growth and cohesion of particles are suppressed appears, and the particle diameters of the particles of the composite material become smaller than those of a single-component material.

In addition, it is preferable that the number of zirconia agglomerates or yttria-zirconia agglomerates is small in the surface of the ball 3, and the number of zirconia agglomerates or yttria-zirconia agglomerates of 10 to 30 μm is more preferably five per 300 mm² and is much more preferably three per 300 mm². Flaking is generated from zirconia agglomerates or yttria-zirconia agglomerates as origins and reduces the rolling life of the ball 3. Note that since agglomerates are not circular in section, the size of agglomerates is determined by a length of a major diameter portion.

To prepare sintered particles whose average particle diameters are 2 μm or smaller and reduce the number of zirconia agglomerates or yttria-zirconia agglomerates in the surface of the ball 3 as is described above, raw material powders having less impurities may be used as is described above, and those powders may be mixed in the bead mill mixer.

The lubricant G may be lubricating oil or grease using the lubricating oil as base oil. In addition, the lubricating oil or the base oil may be nonpolar oil having no polar group such as mineral oil or hydrocarbon oil or polar oil having a polar group such as ester oil. For example, polyα-olefin oil, which is nonpolar oil, is superior in stability, has a resistance to fretting and has a function to suppress the corrosion of the seals 5. On the other hand, the ester oil, which is polar oil, is superior in lubricating performance and heat resistance, and therefore, it is suitable for use in a rolling bearing which rotates at high speeds. For example, in a grease composition used in a motor, it is general practice that when ester oil is used as base oil, a metal soap is used for a thickener, while when polyα-olefin oil is used as base oil, a urea compound is used for a thickener. However, the metal soap is superior in acoustic performance to the urea compound, and hence, when the acoustic performance is considered to be more important, ester oil is used for base oil.

In addition, in order to realize a low torque, the lubricating oil or base oil has preferably a low viscosity, and those whose kinematic viscosity at 40° C. is 80 mm²/s can be used. The surface of the ball 3 has a large adsorption force for polar substances which is originated from the materials used therein. Because of this, by using polar oil for the lubricating oil or base oil, lubricating oil or lubricant having lower viscosity can be used.

However, it is known that an alumina-zirconia composite material is such that a tetragonal system (t-ZrO₂) whose phase is stable at high temperatures is made metastable at room temperature and has high toughness and high strength. It is considered that this is because the propagation of cracks is prevented by a volume thermal expansion occurring at leading ends of cracks when a stress induced martensitic phase transformation from t-ZrO₂ to single crystal (m-ZrO₂) whose phase is stable at low temperatures occurs. However, it is known that the strength of an alumina-zirconia composite material is deteriorated when it is exposed to a high temperature around 200° C. in the air for a long period of time. It is considered that this is because the Zr—O—Zr bonding is interrupted by a chemical reaction between zirconia and water, the phase transformation is promoted by stress corrosion of t-ZrO₂ and fine cracks are generated by volume expansion occurring in association with the phase transformation. In addition, it is now known that this phenomenon is accelerated by not only water but also a solvent such as ammonia (see, Non-Patent Document 1). Because of this, in a friction environment where temperature and pressure are increased, the adsorption of oil molecules having a polarity to the surface of the ball 3 promotes the phase transformation to reduce the surface strength, whereby the surface of the ball 3 easily wears.

In this way, in the ball 3 made of the alumina-zirconia composite material, the adsorption of polar molecules to the surface has two features of lubricating effect and wear promoting effect, and when the bearing is used under high-temperature, high-pressure environment, a nonpolar oil is preferably used.

In addition, the amount of lubricant G filled is preferably small for realization of a low torque, and even when the lubricant G is filled to occupy 20 vol % or smaller of the bearing space 6, a sufficient lubrication can be ensured.

Further, the Young's modulus of the alumina-zirconia composite material which forms the ball 3 is 215 to 280 GPa, and since this is generally smaller than the Young's modulus (208 GPa) of bearing steel or the Young's modulus (207 GPa) of SUJ2 steel which is a metal material used to form the inner ring 1 and the outer ring 2, the resistance to depression is also increased. In contrast to this, the Young's modulus of silicon nitride is 250 to 330 GPa, and since this is larger than the Young's moduli of the bearing steel and SUJ2 steel, silicon nitride is inferior in resistance to depression.

In addition, the density of the alumina-zirconia composite material is 4.5 g/cm³ (the ratio of the alumina component to the zirconia component or the yttria-zirconia component being 50:50) to 6 g/cm³ (the ratio of the alumina component to the zirconia component or the yttria-zirconia component being 5:95), which is smaller than the density (7.8 g/cm³) of the bearing steel. Because of this, the inertial force of the ball 3 is small and colliding noise with the cage 4 becomes small. In addition, when an iron cage is used as the cage 4, the wear of the cage 4 is small, and the acoustic deterioration by iron powder also becomes small. In contrast to this, since the density of silicon nitride is 3.22 g/cm³, with a ball made of silicon nitride, colliding noise with the cage 4 and wear resulting when an iron cage is used become smaller than those of the ball made of the alumina-zirconia composite material. However, with balls made of silicon nitride, there is a drawback that balls tend to pop out at the time of assemblage of a bearing.

Further, the color of the alumina-zirconia composite material is close to white. Because of this, flaws produced in the surface of the ball 3 can easily become visible.

In addition, when expressing the ball accuracy in surface roughness, the ball accuracy is preferably a surface roughness of 0.012 μm or smaller at a sphericity of 0.08 (also, called the G3 level) to a surface roughness of 0.02 μm or smaller at a sphericity of 0.13 (also, called the G5 level). This is because when the ball accuracy surpasses G5 level, the acoustic characteristics are badly affected.

On the other hand, since the inner ring 1 and the outer ring 2 are made of metal such as SUJ2 steel, SUS steel, 13Cr steel or the like, they become inexpensive. Moreover, they are advantageous in acoustic life. In addition, by applying a hardening treatment such as a carbonitriding to at least the raceway surfaces 1a, 2a or preferably the whole surfaces thereof, the wear resistance is preferably increased.

In addition, although the cage 4 may be made of metal, in order to reduce the weight of the bearing in whole or reduce the colliding noise with the balls 3, the cage 4 is preferably formed of a resin composition which is prepared by blending a fabric reinforcement material such as glass fibers or carbon fibers with a heat resistant resin such as polyamide or polyacetal and PPS.

Note that the embodiment illustrates only an example of one form of the invention, and hence, the invention is not limited to the embodiment. For example, in the embodiment, although the deep groove ball bearing is described as the rolling bearing to which the invention is applied, the invention can also be applied to other types of rolling bearings including a radial rolling bearing such as an angular ball bearing, a self aligning ball bearing, a cylindrical roller bearing, a tapered roller bearing, a needle roller bearing, and a self aligning roller bearing or a thrust rolling bearing such as a thrust ball bearing and a thrust roller bearing, and respective rolling elements of those ball and roller bearings are formed of the alumina-zirconia composite material.

### Examples

While the invention will be described further based on tests below, the invention is not limited thereto in any way. Note that in the following tests, the ball accuracies of ball specimens made of the alumina-zirconia composite material were set to G3 to G5.

<Test 1>

An inner ring and an outer ring were made of SUJ2 steel, and ball specimens were prepared using an alumina-zirconia composite material, silicon nitride or SUJ2 steel. Note that the ball specimen made of the alumina-zirconia composite material is such that alumina raw material powder and zirconia raw material powder were mixed together in a ratio of alumina component to zirconia component being 20:80 by mass for sintering. Then, 160 mg of lithium-ester oil based grease (NS Hi-Lube) was filled in each of the specimens, where specimen bearings were prepared. Note that this amount of the filled grease corresponds to 20 vol % of the bearing space.

Then, the respective specimen bearings were caused to rotate continuously at an ambient temperature of 90° C. and 60000 min⁻¹, and the time to reach heat-seizure was measured. The results are shown in Table 1. As is shown therein, the heat-seizing life of the ball specimen made of the alumina-zirconia composite material is double the heat-seizing life of the ball specimen made of silicon nitride, and it is seen that the alumina-zirconia composite material can increase the resistance to heat-seizure largely.

TABLE 1

| Ball Specimen | Heat-Seizing |
|---|---|
| Materials | Time (Hours) |
| Alumina-Zirconia | 568 |
| Silicon Nitride | 274 |
| SUJ2 Steel | 92 |

<Test 2>

The ball specimen made of the alumina-zirconia composite material and the ball specimen made of SUJ2 steel, which were used in Test 1, were compared with each other with respect to calculated life under conditions of room temperature and 60000⁻¹ to find that the life of a specimen bearing employing the ball specimen made of the alumina-zirconia composite material is about 12.8 times longer than that of a specimen bearing employing the ball specimen made of SUJ2 steel.

<Test 3>

Five million reciprocating vibrating motions were applied to the specimen bearings used in Test 1 to obtain a ratio of axial vibration amount before oscillation to axial vibration amount after oscillation. The results are shown in Table 2. It is seen that with the specimen bearing employing the ball specimen made of the alumina-zirconia composite material, the resistance to fretting wear is increased largely.

TABLE 2

| Ball Specimen Materials | Oscillation Amount Ratio |
|---|---|
| Alumina-zirconia | 1 to 4 |
| Silicon Nitride | 5 to 10 |
| SUJ2 Steel | 22 to 31 |

<Test 4>

Friction tests were carried out in various types of lubricating oil to measure change with time of friction coefficient and specific wear rate. The specific wear rate is wear volume per unit friction distance and unit load when solids are caused to rub against each other. The friction tests were carried out as described below. The ball specimen made of SUJ2 steel or the ball specimen made of the alumina-zirconia composite material was rested on a flat plate disc specimen made of SUJ2 steel, and the ball specimen was caused to rotate at a predetermined sliding speed while loading a predetermined load on the ball specimen. Test conditions were as below.
Diameter of Ball Specimen: 5/32 inch
Load: 49N
Sliding Speed: 5 mm/s

Note that the ball specimen made of the alumina-zirconia composite material is such that alumina raw material powder and zirconia raw material powder were mixed together to realize a ratio of alumina component:zirconia component=20:80 for sintering. In addition, lubricating oils are polyα-olefin oil (PAO), polyol ester oil (POE), diester oil, ether oil or glycol oil. The kinematic viscosity at 40° C. of each of these lubricating oils is 30 mm²/s.

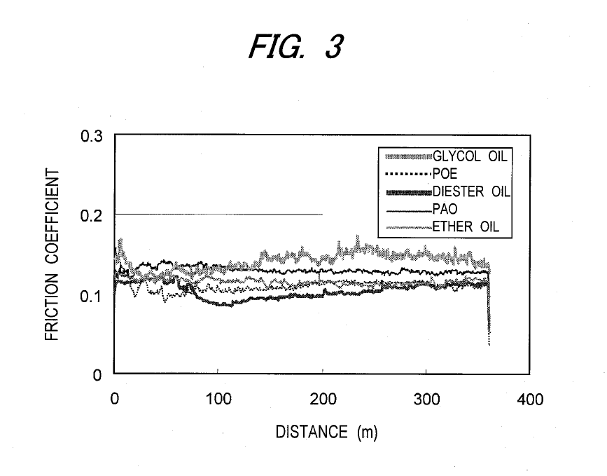

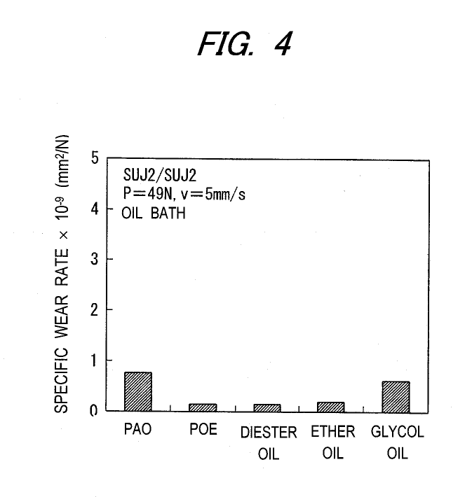

Firstly, referring to FIGS. 3, 4, the results of a test employing the ball specimen made of SUJ2 steel will be described. FIG. 3 is a chart showing changes with time of friction coefficients, and FIG. 4 is a graph showing specific wear rates of the disc specimens. It is seen from FIG. 4 that in the case of friction between metals, wear is small by employing lubricating oil having a polarity such as POE, diester oil, ether oil and glycol oil. It is considered that this is because the direct contact between metals is suppressed by oil molecules being adsorbed on oxides in the surfaces of the metals.

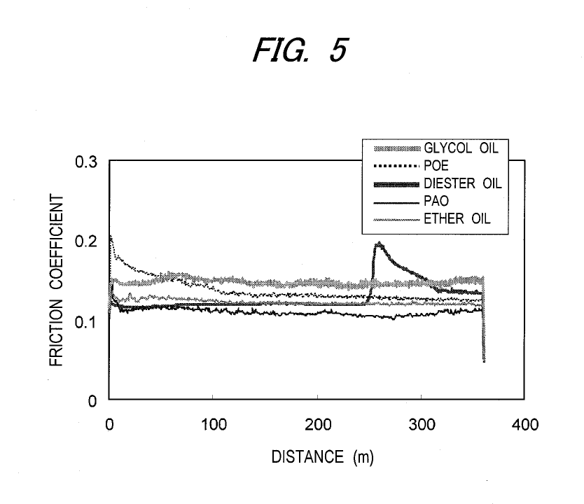

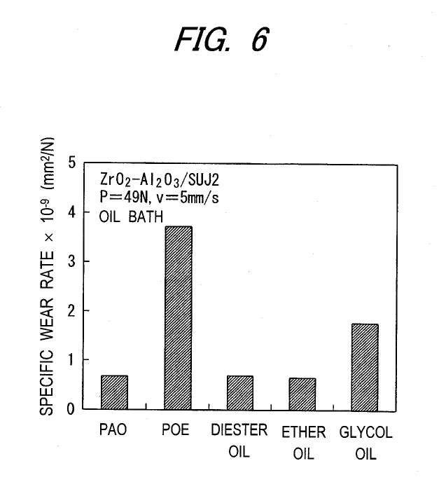

Next, referring to FIGS. 5,6, the results of a test employing the ball specimen made of the alumina-zirconia composite material will be described. FIG. 5 is a chart showing changes with time of friction coefficients, and FIG. 6 is a graph showing specific wear rates of the disc specimens. Since zirconia-alumina is an oxide, as with the case of direct contact between metals, it was considered that with lubricating oil having a polarity, the wear was small. However, as is seen from FIG. 6, when POE and glycol oil, which are polar lubricating oil, were used, the friction coefficient was large and the specific wear rate was also large.

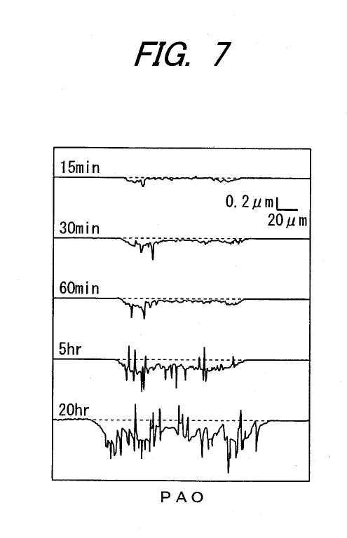

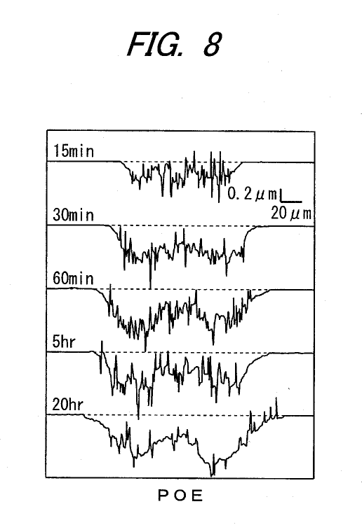

Then, a change with time in surface condition of the ball specimen made of the alumina-zirconia composite material was measured. The results of the measurement are shown in FIGS. 7, 8. As is seen from FIG. 7, in the case of the lubricating oil being PAP having no polarity, wear was small in an early state after the start of the test, the surface condition remained almost free of damage. In contrast to this, in the case of the lubricating oil being POE having polarity, as is seen from FIG. 8, irregularities were formed in the surface and the surface was roughened. Namely, it is was that by the irregularities being formed in the surface of the ball specimen, the function to cut or abrade the disc specimen which is a mating material was considered to be increased, which increased, in turn, the wear of the disc specimen.

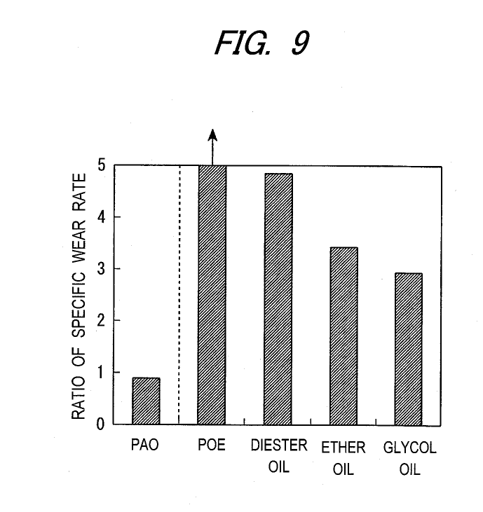

A ratio of the specific wear rate (FIG. 4) when the ball specimen made of SUJ2 steel was used to the specific wear rate (FIG. 6) when the ball specimen made of the alumina-zirconia composite material was used, that is, values obtained by dividing the former by the latter are shown in FIG. 9. These values denote degrees of effects on wear by friction materials with influence on lubricating effects of lubricating oils excluded. Namely, it can be said that lubricating oils whose ratio of specific wear rates shown in FIG. 9 is larger than 1 have a wear promotion effect. It is seen from a graph shown in FIG. 9 that when the ball specimen made of the alumina-zirconia composite material is used, wear is increased by use of the lubricating oil having polarity.

<Test 5>

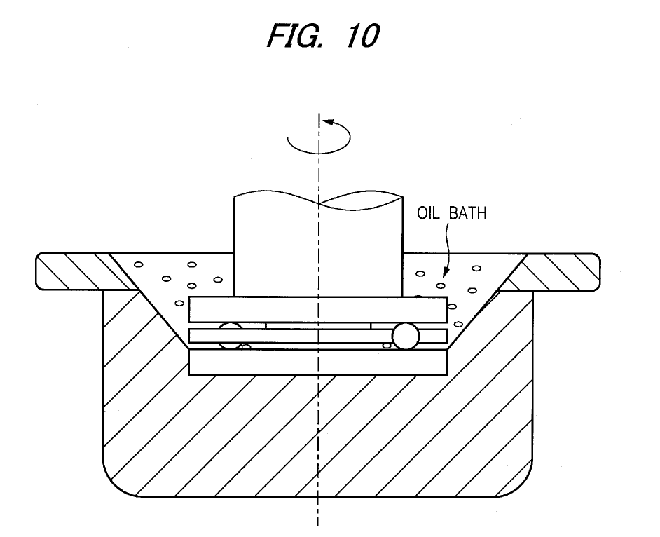

Alumina raw material powder and zirconia raw material powder were mixed together in component ratios (mass %) shown in Table 3 to prepare ball specimens made of alumina-zirconia composite materials, and a thrust test was carried out under test conditions below. Note that a test device was rotated in such a state that a bearing was submerged in an oil bath as is shown in FIG. 10 to obtain vibration values while the test device was rotating. The bearing was disassembled at every predetermined period of time to see if any flaking was generated, and a point in time when flaking was verified was regarded as the life of the bearing. Then, a ratio of measured actual life to calculated life of the 51305 bearing was obtained.
Load: 450 kgf
Diameter of Ball Specimen: ⅜ inch
Number of Balls: 3
Rotational Speed: 1000 rpm
Bearing: 51305 (Inner Ring and Outer Ring being SUJ2)
Lubricating Oil: RO68

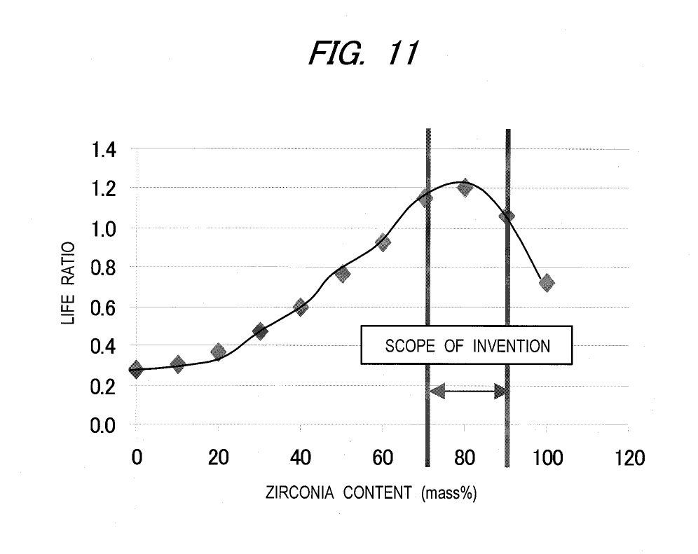

The results of the measurements are shown in FIG. 11. The life ratio to the calculated life becomes below 1 when the alumina component is less than 100 mass % or when the same content surpasses 30 mass %. However, within the range from 10 to 30 mass %, the life ratio surpasses 1, i.e., the life increases.

TABLE 3

| Alumina Component | Zirconia Component | Life |
|---|---|---|
| (mass %) | (mass %) | Ratio |
| 100 | 0 | 0.28 |
| 90 | 10 | 0.30 |
| 80 | 20 | 0.37 |
| 70 | 30 | 0.48 |
| 60 | 40 | 0.60 |
| 50 | 50 | 0.77 |
| 40 | 60 | 0.93 |
| 30 | 70 | 1.15 |
| 20 | 20 | 1.20 |
| 10 | 90 | 1.06 |
| 0 | 100 | 0.73 |

<Test 6>

Alumina raw material powder and yttria-zirconia raw material powder containing 3 mass % yttria were mixed together in component ratios (mass %) shown in Table 4 and the mixtures were sintered to prepare ball specimens. Yttria-zirconia raw material powders containing as an impurity iron oxide in amounts shown in Table 4 were used. Then, life ratios were obtained in test conditions below by following Test 5.
Diameter of Ball Specimen: ⅜ inch
Surface Contact Pressure: 1 GPa
Rotational Speed: 1000 rpm
Bearing: 51305 (Inner Ring and Outer Ring being SUJ2)
Lubricating Oil: VG68

TABLE 4

| Alumina Component | Yttria-Zirconia Component | Iron Oxide |
|---|---|---|
| (mass %) | (mass %) | (mass %) |
| 20 | balance | 0.1 |
| 20 | balance | 0.3 |
| 20 | balance | 0.35 |
| 20 | balance | 0.5 |

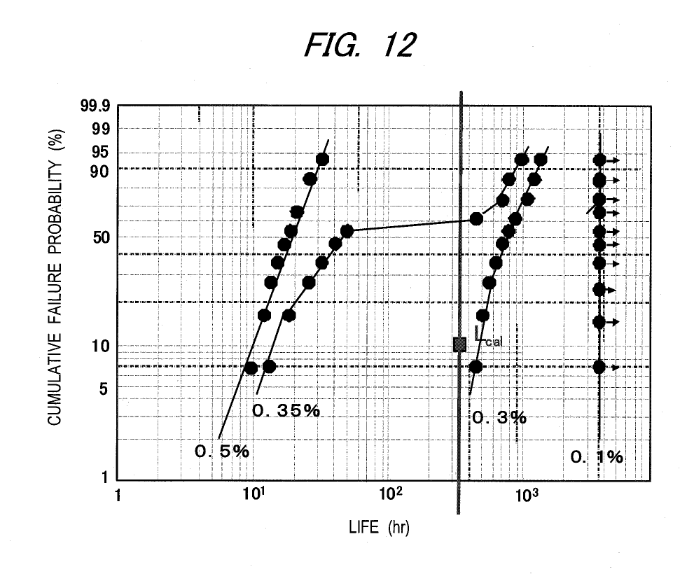

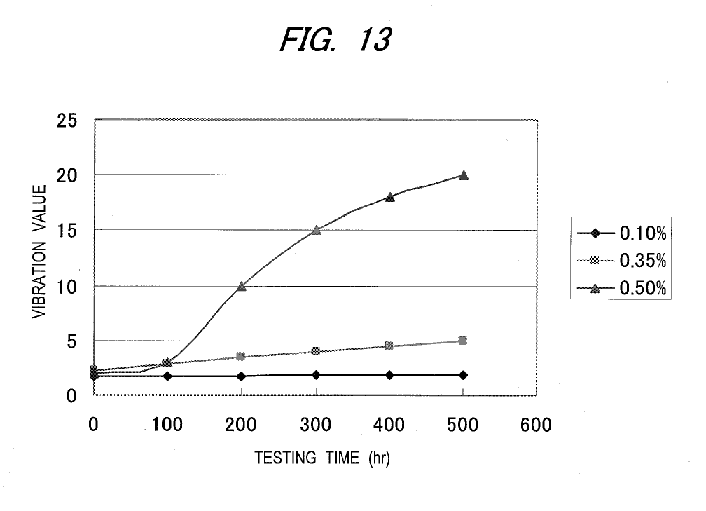

Lives are shown in FIG. 12, and the results of measurement of vibration values are shown in FIG. 13. Flaking originating from iron oxide tends to be generated easily as the content of iron oxide as impurity increases, and the rolling fatigue life is shortened. In addition, crystalline particles start to fall from the surfaces of the ball specimens, and the vibration values are increased. This tendency becomes remarkable when the content of iron oxide surpasses 0.3 mass %.

<Test 7>

Alumina raw material powder and yttria-zirconia raw material powder containing 3 mass % yttria were mixed together in component ratios (mass %) shown in Table 5 using a bead mill mixer while wetting the powders with water, and the mixtures were dried and granulated, formed, degreased, sintered and HIP treated sequentially to prepare stock balls made of alumina-zirconia composite materials. Following this, the stock balls were abraded and were finished into complete balls with a predetermined shape. Then, respective cut surfaces of the complete balls were observed a magnification of ×20000 by use of SEM to measure particle diameters of sintered particles. In the field of view, alumina sintered particles and yttria-zirconia sintered particles are present in a mixed fashion, and particle diameters of sintered particles were obtained without discriminating alumina sintered particles from yttria-zirconia sintered particles to calculate average particle diameters. In addition, life ratios were obtained in the same manner as that of Test 5.

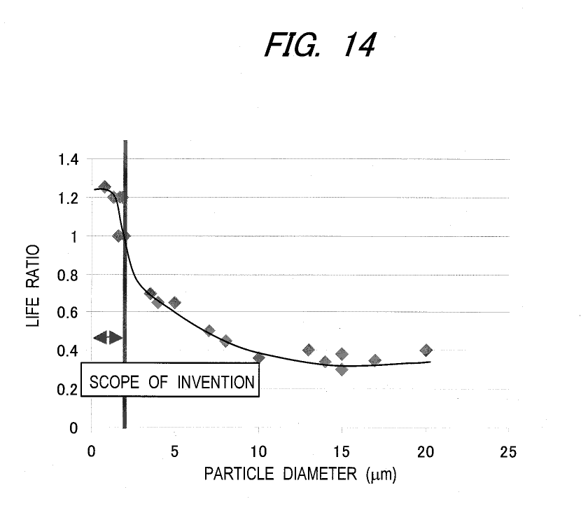

The results of measurements are shown in Table 5 and FIG. 14. As the average particle diameters increase, lives are shortened, and this tendency becomes remarkable when the average particle diameter surpasses 2 μm. In addition, as is shown in Table 5, it is seen that in order to make the average particle diameter equal to or smaller than 2 μm, the alumina component may be 30 mass % or smaller.

TABLE 5

| Alumina Component | Yttria-Zirconia | Average Particle | Life |
|---|---|---|---|
| (mass %) | Component (mass %) | Diameter (μm) | Ratio |
| 100 | 0 | 20 | 0.40 |
| 90 | 10 | 17 | 0.35 |
| 80 | 20 | 14 | 0.34 |
| 70 | 30 | 15 | 0.30 |
| 60 | 40 | 10 | 0.36 |
| 50 | 50 | 8 | 0.45 |
| 40 | 60 | 4 | 0.65 |
| 35 | 65 | 3.5 | 0.70 |
| 30 | 70 | 1.8 | 1.20 |
| 25 | 75 | 1.3 | 1.20 |
| 20 | 80 | 0.8 | 1.25 |
| 20 | 80 | 1.6 | 1.00 |
| 15 | 85 | 2 | 1.00 |
| 15 | 85 | 1.7 | 1.20 |
| 8 | 92 | 5 | 0.65 |
| 5 | 95 | 7 | 0.50 |
| 0 | 100 | 13 | 0.40 |
| 0 | 100 | 15 | 0.38 |

<Test 8>

20 mass % of alumina raw material powders and 80 mass % of zirconia raw material powders were mixed together, the mixtures were sintered under different sintering conditions to prepare various types of ball specimens, and dimensions of major axis portions of zirconia agglomerates were measured by observing surfaces of the ball specimens. Then, life rations were obtained in accordance with Test 5.

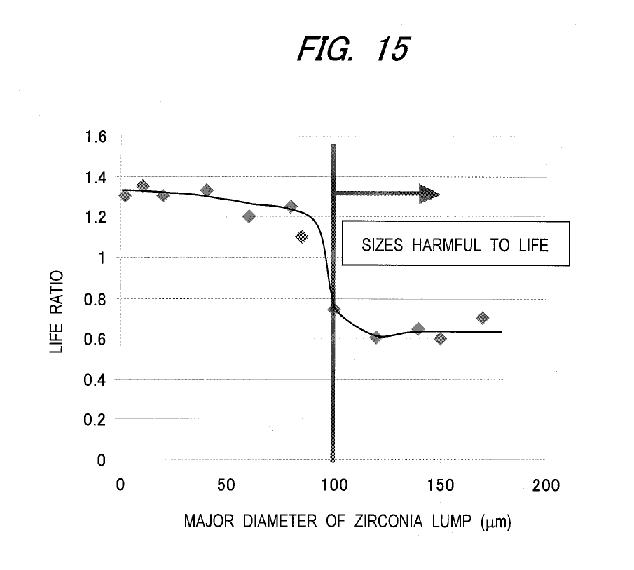

The results of measurements are shown in Table 6 and FIG. 15. It is seen that when zirconia agglomerates of large diameters which surpass 100 μm are present, lives are largely reduced.

TABLE 6

| Dimensions of Zirconia | Life |
|---|---|
| Agglomerates (μm) | Ratio |
| 2 | 1.30 |
| 10 | 1.35 |
| 20 | 1.30 |
| 40 | 1.33 |
| 60 | 1.20 |
| 80 | 1.25 |
| 85 | 1.10 |
| 100 | 0.74 |
| 120 | 0.61 |
| 140 | 0.65 |
| 150 | 0.60 |
| 170 | 0.70 |

<Test 9>

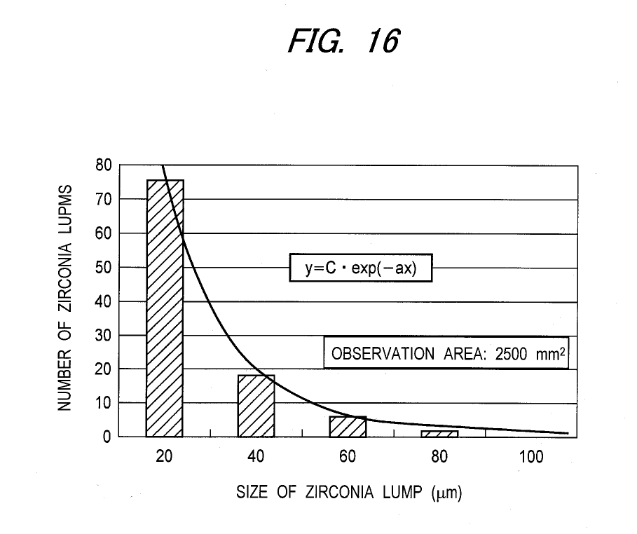

As is indicated by the results obtained in Test 8, since a zirconia agglomerate observed from an origin of flaking surpasses 100 μm, the life becomes lower than the calculated life, in order to guarantee the life of the rolling element, the surface of the rolling element is to be observed to verify that no agglomerate whose particle diameter is 100 μm is not present in the surface. However, in the actual surface of the rolling element which is prepared under sufficient control of powder production conditions such as pulverization, mixing, drying and granulation, the frequency at which zirconia agglomerates of 100 μm or larger appear is low, and the total inspection of surfaces of rolling elements is difficult in reality from the viewpoints of labor and cost. In addition, cracks are generated directly under the surface of the rolling bearing although they are not visible from above the surface, and to verify the existence of cracks, life tests had to be carried out direct on the balls. Then, in order to grasp how zirconia agglomerates are present in the surface of the rolling element, firstly, rolling elements were sampled to inspect the surfaces thereof and investigate the distribution of zirconia agglomerates. As a result, it is seen that a relationship between size and number of zirconia agglomerates follows an exponential distribution shown in FIG. 16. Note that in an expression in the figure, y denotes the number of zirconia agglomerates, x denotes the size of a zirconia agglomerate, and c and a are constant which are determined as testal values. It was seen that in addition to this exponential distribution, when the numbers of zirconia agglomerates of 10 to 30 μm and 100 μm which appearance frequencies can easily be observed in reality are obtained, the number of zirconia agglomerates whose particle diameter or size is 100 μm and which are harmful to extension of life can be grasped from the number of zirconia agglomerates of 10 to 30 μm. Further, in order to make reliable the estimated number of zirconia agglomerates whose particle diameter or size is 100 μm and which are harmful to extension of life, an area to be observed was studied based on statistic thinking to find that a sufficient reliability could be obtained in case an area of 300 mm² was observed. Then, in order to investigate a relationship between the number of zirconia agglomerates of 10 to 30 gm in size which are present in that area and life, the following life test was carried out.

Namely, 20 mass % of alumina raw material powders and 80 mass % of zirconia raw material powders were mixed together, the mixtures were sintered under different sintering conditions to prepare various types of ball specimens, and the number of zirconia agglomerates of 10 to 30 μm per 300 mm² was measured. Then, life ratios were obtained in accordance with Test 5.
Diameter of Ball Specimen: ⅜ inch
Load: 740 kgf
Number of Balls: 6
Rotational Speed: 1000 rpm
Bearing: 51305 (Inner Ring and Outer Ring being SUJ2)
Lubricating Oil: RO68

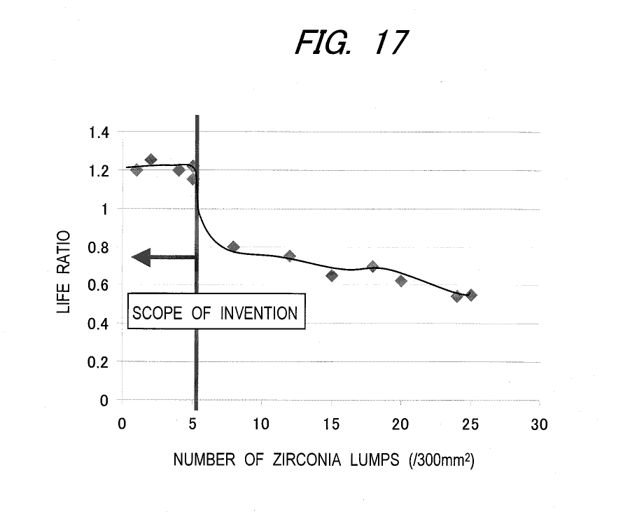

The results of measurements are shown in Table 7 and FIG. 17. It is seen that when more than five zirconia agglomerates of 10 to 30 μm are present per 300 mm², the life of the ball is largely reduced.

TABLE 7

| Number of Zirconia Agglomerates | Life |
|---|---|
| of 10 to 30 μm per 300 mm² | Ratio |
| 1 | 1.20 |
| 2 | 1.25 |
| 4 | 1.20 |
| 5 | 1.22 |
| 8 | 0.80 |
| 12 | 0.76 |
| 15 | 0.65 |
| 18 | 0.70 |
| 20 | 0.62 |
| 24 | 0.54 |
| 25 | 0.55 |

<Test 10>

Based on Tests 7 to 9, ball specimens were prepared by changing the component ratio (mass %) of alumina component to zirconia component and sintering conditions as is shown in FIG. 8. Then, respective cut surfaces of the ball specimens were observed a magnification of ×20000 by use of SEM, and particle diameters of sintered particles were measured so as to obtain average particle diameters. The number of zirconia agglomerates of 10 to 30 μm per 300 mm² was also measured. Further, life ratios were obtained in the same way as that of Test 9.

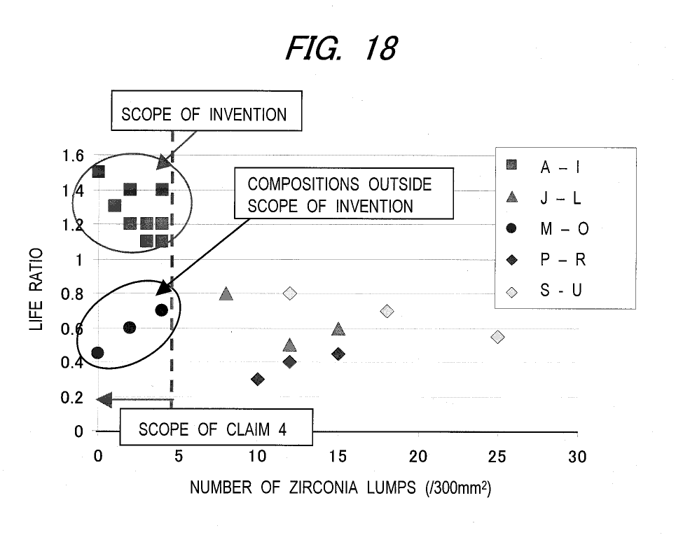

The results of measurement are shown in Table 8 and FIG. 18. It is seen that when the alumina component is 10 to 30 mass %, the particle diameters of alumina-zirconia composite particles in the ball specimens can be suppressed to 2 μm or smaller, the number of zirconia agglomerates of 10 to 30 μm can be suppressed to five or less per 300 mm², and the life of the rolling element is extended.

TABLE 8

| | | | | Number of | |
|---|---|---|---|---|---|
| | | | Average | Zirconia | |
| | Alumina | Zirconia | Particle | Agglomerates | |
| Spec- | Component | Component | Diameter | of 10 to 30 μm | Life |
| imen | (mass %) | (mass %) | (μm) | per 300 mm² | Ratio |
| A | 20 | 80 | 0.8 | 0 | 1.50 |
| B | 20 | 80 | 1.2 | 2 | 1.40 |
| C | 20 | 80 | 1.4 | 4 | 1.40 |
| D | 30 | 70 | 1.6 | 2 | 1.20 |
| E | 30 | 70 | 1.7 | 3 | 1.10 |
| F | 30 | 70 | 1.3 | 4 | 1.10 |
| G | 10 | 90 | 1.8 | 1 | 1.30 |
| H | 10 | 90 | 2.0 | 3 | 1.20 |
| I | 10 | 90 | 1.9 | 4 | 1.20 |
| J | 0 | 100 | 12 | 15 | 0.60 |
| K | 3 | 97 | 10 | 12 | 0.50 |
| L | 5 | 95 | 8 | 8 | 0.80 |
| M | 40 | 60 | 4 | 4 | 0.70 |
| N | 60 | 40 | 10 | 2 | 0.60 |
| O | 80 | 20 | 15 | 0 | 0.45 |
| P | 40 | 60 | 7 | 15 | 0.45 |
| Q | 70 | 30 | 18 | 12 | 0.40 |
| R | 100 | 0 | 24 | 10 | 0.30 |
| S | 20 | 80 | 1.3 | 12 | 0.80 |
| T | 20 | 80 | 1.5 | 18 | 0.70 |
| U | 20 | 80 | 1.5 | 25 | 0.55 |

<Test 11>

20 mass % of alumina raw material powders and 80 mass % of zirconia raw material powders were introduced into a ball mill mixer together with zirconia pulverization media whose diameter was 10 mm and were mixed together at 600 rpm. Then, the mixture was formed into a spherical shape and sintered so as to prepare a ball specimen A of ⅜ inch in diameter.

20 mass % of alumina raw material powders and 80 mass % of zirconia raw material powders were introduced into a bead mill mixer (see FIG. 2) together with zirconia pulverization media whose diameter was 1 mm and were mixed together at 2000 rpm. Then, the mixture was formed into a spherical shape and sintered so as to prepare a ball specimen B of ⅜ inch in diameter.

A life test was carried out using the ball specimens A, B under the following test conditions. Then, a thrust test (see FIG. 11) was carried out in the following test conditions, and bearings were disassembled at every predetermined period of time to verify flaking in the surfaces of the ball specimens. A point in time when flaking was verified was determined to be the life of the balls.
Diameter of Ball Specimen: ⅜ inch
Surface Contact Pressure: 1 GPa
Rotational Speed: 1000 rpm
Bearing: 51305 (Inner Ring and Outer Ring being SUJ2)
Lubricating Oil: VG68

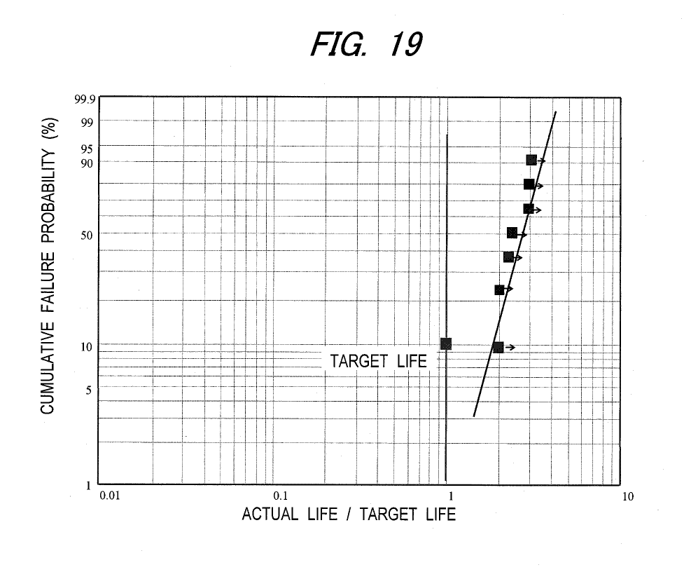

The results of measurements are shown in FIG. 19. In the bearing including the ball specimens B prepared by use of the bead mill mixer surpasses a target life.

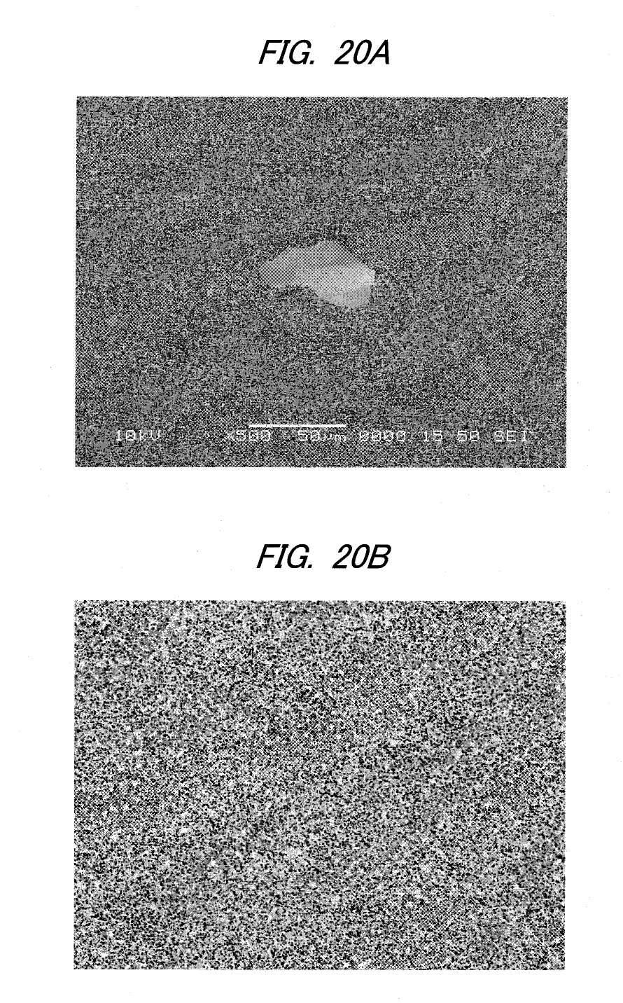

In addition, internal textures of the ball specimens A, B were SEM photographed. FIG. 20A is an SEM photograph of the internal texture of the ball specimen prepared by use of the ball mill mixer, and FIG. 20B is an SEM photograph of the internal texture of the ball specimen prepared by use of the bead mill mixer. A large agglomerate of segregation is visible in the ball specimen A, whereas no agglomerate of segregation is visible in the ball specimen B.

While the invention has been described in detail and based on the specific embodiment, it is obvious to those skilled in the art to which the invention pertains that various alterations or modifications can be made thereto without departing from the spirit and scope of the invention.

The present application is based on Japanese Patent Application No. 2009-123072 filed on May 21, 2009 and Japanese Patent Application No. 2010-035213 filed on Feb. 19, 2010, the contents of which are incorporated herein by reference.

### INDUSTRIAL APPLICABILITY

The invention is suitable for a rolling bearing used in, for example, inverter controlled motors for motors of air conditioner fans and compressors, pivot arms for supporting a swing arm of an HDD and oscillating motors such as servo motors or stepping motors.

### EXPLANATION OF REFERENCE SIGNS

1 Inner Ring
2 Outer Ring
3 Ball
4 Cage
5 Seal
6 Bearing Space
G Lubricant

1. A rolling bearing comprising at least an inner ring, an outer ring, a rolling element, and a cage,
wherein the rolling element is made of an alumina-zirconia composite material including an alumina component and either a zirconia component or a yttria-zirconia component containing 1.5 to 5 mol % of yttria, a mass ratio of the alumina component to the zirconia component or the yttria-zirconia component being 5:95 to 50:50.

2. The rolling bearing as set forth in claim 1, wherein alumina particles and either zirconia particles or yttria-zirconia particles in the rolling element respectively have an average particle diameter of 2 μm or smaller.

3. The rolling bearing as set forth in claim 1, wherein each content of SiO₂, Na₂O and Fe₂O₃ in the rolling element is 0.3 mass % or smaller respectively.

4. The rolling bearing as set forth in claim 1, wherein, in a surface of the rolling element, number of zirconia agglomerates or yttria-zirconia agglomerates having a size of 10 to 30 μm is five or less per 300 mm².

5. The rolling bearing as set forth in claim 1, wherein Young's modulus of the rolling element is 215 to 280 GPa.

6. The rolling bearing as set forth in claim 1, wherein a density of the rolling element is 4.5 to 6 g/cm³.

7. The rolling bearing as set forth in claim 1, wherein the cage is made of a synthetic resin composition.

8. The rolling bearing as set forth in claim 1, wherein at least one of the inner ring and the outer ring is carbonitrided.

9. The rolling bearing as set forth in claim 1, wherein an ester oil having kinematic viscosity of 80 mm²/s or smaller at 40° C. or a grease using the ester oil as a base oil is enclosed to occupy 20 vol % or less of a bearing space.

10. The rolling bearing as set forth in claim 1, wherein a nonpolar lubricating oil having kinematic viscosity of 80 mm²/s or smaller at 40° C. and having no polar group in molecules, or a grease using the nonpolar lubricating oil as a base oil is enclosed to occupy 20 vol % or smaller of a bearing space.

11. A rolling bearing manufacturing method, the rolling bearing comprising at least an inner ring, an outer ring, a rolling element, and a cage, the method comprising:
mixing alumina raw material powers and either zirconia raw material powders or yttria-zirconia raw material powers containing 1.5 to 5 mol % of yttria, in a mass ratio of the alumina raw material powders to the zirconia raw material powders or the yttria-zirconia raw material powders being 5:95 to 50:50;
molding the mixture into a shape of the rolling element; and
sintering, after the molding, the molded mixture to fabricate the rolling element.

12. The rolling bearing manufacturing method as set forth in claim 11, wherein the mixing comprises pulverizing the alumina raw material powder and either the zirconia raw material powder or the yttria-zirconia raw material powder inside a bead mill mixer together with zirconia beads having a diameter of 1 mm or smaller.

13. A rolling bearing comprising at least an inner ring, an outer ring, a rolling element, and a cage,
wherein the rolling element is made of an alumina-zirconia composite material including an alumina component and either a zirconia component or a yttria-zirconia component containing 1.5 to 5 mol % of yttria, a mass ratio of the alumina component to the zirconia component or the yttria-zirconia component being 5:95 to 50:50,
alumina particles and either zirconia particles or yttria-zirconia particles in the rolling element respectively have an average particle diameter of 2 μm or smaller,
each content of SiO₂, Na₂O and Fe₂O₃ in the rolling element is 0.3 mass % or smaller respectively,
in a surface of the rolling element, number of zirconia lumps or yttria-zirconia lumps having a size of 10 to 30 μm is five or less per 300 mm²,
Young's modulus of the rolling element is 215 to 280 GPa,
a density of the rolling element is 4.5 to 6 g/cm³,
the cage is made of a synthetic resin composition, and
at least one of the inner ring and the outer ring is carbonitrided.

14. The rolling bearing as set forth in claim 13, wherein an ester oil having kinematic viscosity of 80 mm²/s or smaller at 40° C. or a grease using the ester oil as a base oil is enclosed to occupy 20 vol % or less of a bearing space.

15. The rolling bearing as set forth in claim 13, wherein a nonpolar lubricating oil having kinematic viscosity of 80 mm²/s or smaller at 40° C. and having no polar group in molecules, or a grease using the nonpolar lubricating oil as a base oil is enclosed to occupy 20 vol % or smaller of a bearing space.
